(19) United States
(12) Patent Application Publication
(10) Pub. No.: US 2026/0065833 A1
(43) Pub. Date: Mar. 5, 2026

(54) DISPLAY DEVICE AND DRIVE CIRCUIT

(71) Applicant: Glenfly Tech Co., Ltd., Shanghai (CN)

(72) Inventors: Wenwei XU, Shanghai (CN); Zhifeng MAO, Shanghai (CN)

(21) Appl. No.: 19/224,343

(22) Filed: May 30, 2025

(30) Foreign Application Priority Data
Aug. 29, 2024 (CN) 202411204125.6

(51) Int. Cl. G09G 3/20

(52) U.S. Cl. CPC G09G 3/2092; G09G 2300/0814; G09G 2300/0828; G09G 2300/0871; G09G 2310/0251; G09G 2310/08; G09G 2330/021

(57) ABSTRACT

A drive circuit for a display device includes one or more data channel units, a first and second capacitors, and a comparison unit. The data channel unit includes a data channel, a judgment unit, a logic operation unit, a first control switch and a second control switch. The first control switch is connected to the output end of the data channel and one end of the first capacitor which is connected to the comparison unit. The second control switch is connected to the output end of the data channel and one end of the second capacitor which is connected to the first capacitor. Two output terminals of the logic operation unit are configured to output first and second switch control signals to control the switching of the first and second control switches.

### CROSS-REFERENCE TO RELATED APPLICATIONS

The present disclosure claims priority to the Chinese patent application No. 202411204125.6, filed on Aug. 29, 2024, titled “DISPLAY DEVICE AND DRIVE CIRCUIT”, the content of which is hereby incorporated by reference in its entity.

### TECHNICAL FIELD

The present disclosure relates to the technical field of display devices, particularly to a display device and a drive circuit for the display device.

### BACKGROUND

A drive circuit applied to a display device typically collects residual charges from data lines on a panel and stores these residual charges in a capacitor of the drive circuit. Then, during the next charging process, the charges stored in the capacitor can be used to charge the data lines.

However, in practical applications, voltage changes of multiple data lines are irregular, which may lead to situations where, in some cases, it is not possible to collect the residual charges from the data lines and store them in the capacitor.

### SUMMARY

One aspect of the present disclosure provides a drive circuit for a display device, which includes one or more data channel units, a first capacitor, a second capacitor, and a comparison unit. Two input terminals of the comparison unit are connected to one end of the first capacitor and a reference voltage respectively. The other end of the first capacitor is connected to one end of the second capacitor. The one or more data channel units each include:
a data channel, an input terminal of the data channel being configured to receive an input signal, and the output terminal of the data channel being configured to output an output signal;
a judgment unit, connected to the data channel and configured to determine a state of the input signal;
a first control switch and a second control switch, the first control switch being connected to the output terminal of the data channel and one end of the first capacitor connected to the comparison unit, and the second control switch being connected to the output terminal of the data channel and one end of the second capacitor connected to the first capacitor; and
a logic operation unit, two input terminals of the logic operation unit being connected to an output terminal of the comparison unit and an output terminal of the judgment unit, respectively, a first output terminal of the logic operation unit being configured to output a first switch control signal to control switching of the first control switch, and a second output terminal of the logic operation unit being configured to output a second switch control signal to control switching of the second control switch.

In some embodiments, the data channel includes a latch unit, a level shift unit, a digital-to-analog conversion unit, and an operational amplifier unit, which are connected in series. The latch unit is configured to cache the input signal, the level shift unit is configured to perform level conversion on the input signal cached by the latch unit, the digital-to-analog conversion unit is configured to perform digital-to-analog conversion on an output signal of the level shift unit, and the operational amplifier unit is configured to amplify an output signal of the digital-to-analog conversion unit to obtain the output signal of the data channel.

In some embodiments, an input terminal of the judging unit is connected to an output terminal of the latch unit.

In some embodiments, the output terminal of the data channel is configured to be connected to an external data line, and the first capacitor and the second capacitor are configured to collect residual charge on the data line and charge the data line with the collected charge.

In some embodiments, the data channel unit further includes a data channel switch, the data channel switch is connected in the data channel and positioned upstream of connection points between the data channel and the first control switch and the second control switch, and is configured to control a connection state between the data channel and the data line.

In some embodiments, the drive circuit further includes a control unit configured to turn off the data channel switch before a change occurs in the input signal.

In some embodiments, a gate of the first control switch is connected to the first output terminal of the logic operation unit, a drain of the first control switch is connected to the end of the first capacitor connected to the comparison unit, and a source of the first control switch is connected to the output terminal of the data channel. A gate of the second control switch is connected to the second output terminal of the logic operation unit, a drain of the second control switch is connected to the end of the second capacitor connected to the first capacitor, and a source of the second control switch is connected to the output terminal of the data channel.

In some embodiments, a voltage at the end of the first capacitor connected to the comparison unit is denoted as VEQ, and the logic operation circuit is configured to:
when the input signal of the data channel transitions from low to high and the voltage VEQ is at a high level, turn on the first control switch and turn off the second control switch to close a circuit between the first capacitor and the data line; and
when the input signal of the data channel transitions from low to high and the voltage VEQ is at a low level, turn off both the first control switch and the second control switch to disconnect the circuit the first capacitor and data line and a circuit between the second capacitor and the data line.

In some embodiments, a voltage at the end of the first capacitor connected to the comparison unit is denoted as voltage VEQ, and the logic operation circuit is configured to:
when the input signal of the data channel transitions from high to low and the voltage VEQ is at a high level, turn off the first control switch and turn on the second control switch to close a circuit between the second capacitor and the data line; and
when the input signal of the data channel transitions from high to low and the voltage VEQ is at a low level, turn on the first control switch and turn off the second control switch to close a circuit between the first capacitor and the data line.

In some embodiments, the one or more data channel units include a plurality of independent data channel units, and the data channels of the plurality of data channel units are configured to receive the input signals with same or different variation modes.

Another aspect of the present disclosure provides a display device, which includes a drive circuit according to any one of the above-described embodiments and one or more data lines connected to the drive circuit.

Yet another aspect of the present disclosure provides a control method for a display device. The display device includes the drive circuit according to any one of the above-described embodiments. The control method includes turning off the data channel switch before the input signal changes.

The details of one or more embodiments of the present application are presented in the following drawings and descriptions. Other features, objectives, and advantages of the present application will become apparent from the description, drawings, and claims.

### BRIEF DESCRIPTION OF THE DRAWINGS

In order to more clearly illustrate the technical solutions in the embodiments of the present disclosure or the prior art, the following is a brief introduction to the drawings used in the description of the embodiments or prior art. It is obvious that the drawings described below are only some embodiments of the present disclosure. For those skilled in the art, without creative effort, other drawings can also be derived from these drawings.

FIG. 1 is a schematic diagram of a structure of a drive circuit for a display device in related arts.

FIG. 2 is a schematic diagram of a structure of another drive circuit for a display device in related arts.

FIG. 3 is an exemplary signal timing diagram corresponding to the drive circuit in FIG. 2.

FIG. 4 is a schematic diagram of a drive circuit for a display device in some embodiments of the present disclosure.

FIG. 5 is a schematic diagram of a structure of a data channel in some embodiments of the present disclosure.

FIG. 6 is a schematic diagram of a structure of a drive circuit for a display device in some embodiments of the present disclosure.

FIG. 7 is a schematic diagram of the structure of the drive circuit for a display device in other embodiments of the present disclosure, where two data channels are used.

FIG. 8 is an exemplary signal timing diagram corresponding to the drive circuit in FIG. 7.

### DETAILED DESCRIPTION

To facilitate understanding of the present disclosure, the following provides a more comprehensive description of the present disclosure with reference to the relevant drawings. The drawings show the embodiments of the present disclosure. However, the present disclosure can be implemented in many different forms and is not limited to the embodiments described herein. Rather, the purpose of providing these embodiments is to make the disclosure of the present disclosure more thorough and complete.

Unless otherwise defined, all technical and scientific terms used herein have the same meaning as understood by those skilled in the art to which the present disclosure pertains. The terms used in the description of the present disclosure are for the purpose of describing specific embodiments and are not intended to limit the application.

It can be understood that the terms “first”, “second”, etc., as used in the present disclosure may be used to describe various elements, but these elements are not limited by these terms. These terms are merely used to distinguish one element from another. For example, without departing from the scope of the present disclosure, a first resistor can be referred to as a second resistor, and similarly, a second resistor can be referred to as a first resistor. Both the first and second resistors are resistors, but they are not the same resistor.

It can also be understood that in the following embodiments, the term “connection”, when referring to connected circuits, modules, units, etc., means that there is a transfer of electrical signals or data between the connected elements, and should be understood as “electrical connection”, “communication connection”, etc. The connection between two elements can be a direct connection or an indirect connection with other devices between them.

It can be understood that “at least one” refers to one or more, and “multiple” refers to two or more. “At least part of the component”refers to part or all of the component.

When used here, the singular forms of “one”, “a”, and “the” may also include the plural form, unless the context clearly indicates otherwise. It should also be understood that the terms “include/including” or “have” designate the existence of the stated features, whole, steps, operations, components, parts, or combinations thereof, but do not exclude the possibility of the existence or addition of one or more other features, wholes, steps, operations, components, parts, or combinations thereof. Additionally, the term “and/or” used in this specification includes any and all combinations of the listed items.

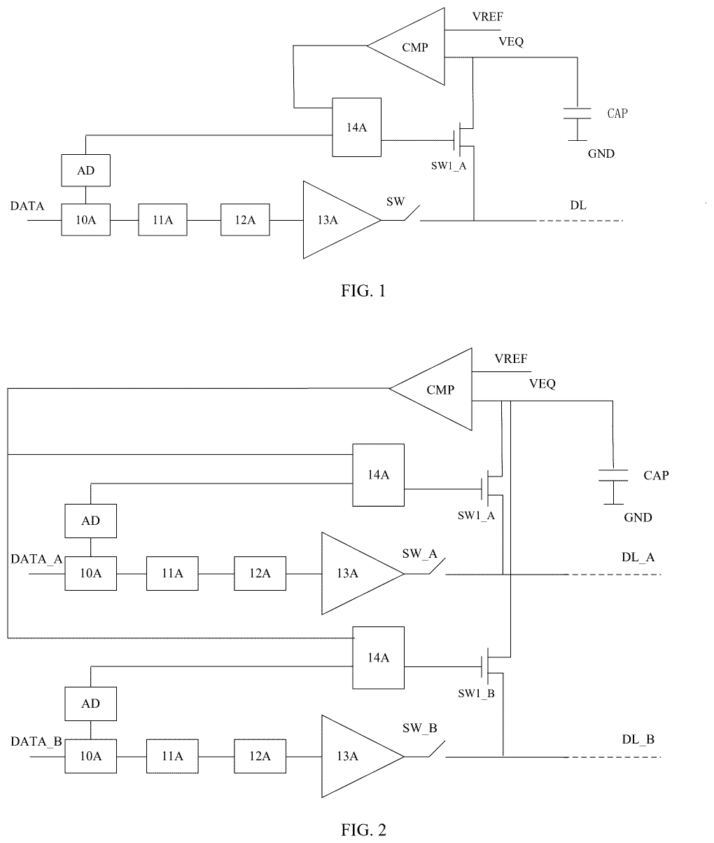

FIG. 1 shows a structure of a drive circuit for a display device related to the present disclosure. As shown in FIG. 1, the drive circuit includes a data channel, a logic operation unit 14A, a judgment unit AD, a comparison unit CMP, a first control switch SW1_A, and a capacitor CAP. The data channel further includes a latch unit 10A, a level shifting unit 11A, a digital-to-analog converter unit 12A, an operational amplifier unit 13A, and a data channel switch SW, which are connected in series. The data channel is connected to an external data line DL through the data channel switch SW. The first control switch SW1_A can be, for example, a MOSFET (Metal-Oxide-Semiconductor Field-Effect Transistor). One end of the judgment unit AD is connected to the latch unit 10A, and the other end is connected to a first input of the logic operation unit 14A. The first input of the comparison unit CMP is connected to a reference voltage VREF, and the second input is connected to one end of the capacitor CAP. The other end of the capacitor CAP is grounded. The output of the comparison unit CMP is connected to a second input of the logic operation unit 14A. The output of the logic operation unit 14A is connected to the gate of the first control switch SW1_A. The drain of the first control switch SW1_A is connected to the end of the capacitor CAP that is connected to the second input of the comparison unit CMP, and the source of the first control switch SW1_A is connected to the data line DL.

Exemplarily, with reference to FIG. 1, when the input data DATA for the data channel changes from a low voltage level to a high voltage level (indicating that the data line DL is to change from low to high), and the voltage VEQ at the end of the capacitor connected to the comparison unit CMP exceeds the reference voltage VREF, a comparison result from the comparison unit CMP and a judgment result from the judgment unit AD are transmitted to the logic operation unit 14A. The logic operation unit 14A controls the first control switch SW1_A to turn on, allowing the capacitor CAP to charge the data line DL to a certain voltage. When the input data DATA changes from a high voltage level to a low voltage level (indicating that the data line DL is to change from high to low), and the voltage VEQ is lower than the reference voltage VREF, the comparison result from the comparison unit CMP and the judgment result from the judgment unit AD are transmitted to the logic operation unit 14A. The logic operation unit 14A controls the first control switch SW1_A to turn on, collecting the charge on the data line DL and storing it in the capacitor CAP.

However, in the case of multiple data lines, the voltage variations on these lines are irregular. Therefore, under certain conditions, there are cases where some data lines, when changing from a high level to a low level, cannot collect the residual charge on the data lines and store it in the capacitor.

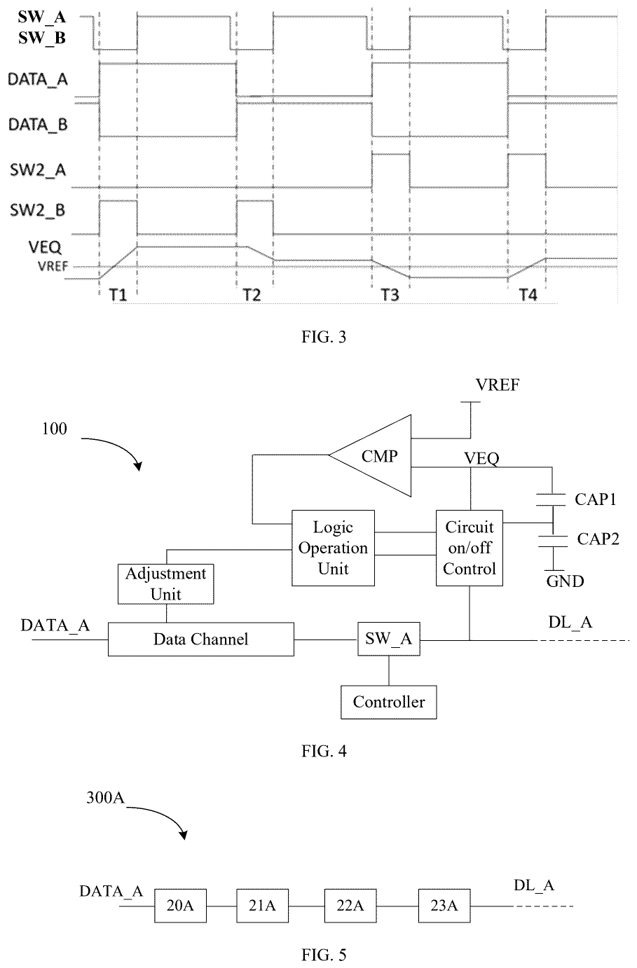

FIG. 2 is a schematic diagram of a structure of another drive circuit for a display device in related arts, where the drive circuit includes two data channels. FIG. 3 is a timing diagram showing an exemplary signal change for the drive circuit in FIG. 2. The input signals corresponding to the two data channels are denoted as DATA_A and DATA_B, and the corresponding data lines are denoted as DL_A and DL_B. The voltage at the end of the capacitor CAP connected to the comparison unit CMP is denoted as VEQ, and the reference voltage is denoted as VREF. The first control switch that controls the connection and disconnection between the data line DL_A and the capacitor CAP is labeled SW1_A, and the switch controlling the connection and disconnection between the data line DL_B and the capacitor CAP is labeled SW1_B. The data channel switch corresponding to the data line DL_A is labeled SW_A, and the data channel switch corresponding to the data line DL_B is labeled SW_B.

Referring to FIG. 3, an exemplary control process based on the drive circuit shown in FIG. 2 is as follows.

Initially, the voltage VEQ is less than the reference voltage VREF. During the first period T1, the signal DATA_B transitions from high to low. At this moment, the first control switch SW1_B is turned on, and the residual charge on data line DL_B is used to charge capacitor CAP. The voltage VEQ rises until VEQ is charged to a value greater than the reference voltage VREF, at which point charging stops.

During the second period T2, the signal DATA_B transitions from low to high, and the signal DATA_A transitions from high to low. At this moment, the first control switch SW1_B is turned on, and the charge stored in capacitor CAP is used to charge the data line DL_B. As a result, the voltage VEQ decreases. Assuming the voltage VEQ after the decrease is still greater than reference voltage VREF, since the signal DATA_A is at a low level, the first control switch SW1_A is turned off, causing the residual charge on data line DL_A not to be collected and stored.

During the third period T3, the signal DATA_A transitions from low to high, and the signal DATA_B transitions from high to low. At this moment, the first control switch SW1_A is turned on, and the charge stored in capacitor CAP is used to charge the data line DL_A, causing the voltage VEQ to decrease. When the voltage VEQ drops below the reference voltage VREF, the first control switch SW1_B is turned off, causing the residual charge on data line DL_B not to be collected and stored.

During the fourth period T4, the signal DATA_A transitions from high to low, and the first control switch SW1_A is turned on, using the residual charge on data line DL_A to charge the first capacitor CAP1, thus charging the voltage VEQ to a value greater than the reference voltage VREF.

From the working process of the four time periods described above, it can be seen that during periods T2 and T3, there are cases where the residual charge on the data lines is not stored.

To address the issues with the drive circuit described above, the present application provides a drive circuit for a display device, which includes one or more data channel units, a first capacitor, a second capacitor, and a comparison unit. Two inputs of the comparison unit are connected to one end of a first capacitor and a reference voltage, respectively. The other end of the first capacitor is connected to one end of a second capacitor.

In some embodiments, the data channel unit includes a data channel, a judgment unit, a logic operation unit, a first control switch and a second control switch.

An input terminal of the data channel is configured to receive an input signal, and an output terminal of the data channel is configured to output an output signal. The judgment unit is connected to the data channel and is configured to determine the state of the input signal. The first control switch is configured to connect the output terminal of the data channel to the end of the first capacitor that is connected to the comparison unit. The second control switch is configured to connect the output terminal of the data channel to the end of the second capacitor that is connected to the first capacitor. Two input terminals of the logic operation unit are connected to an output terminal of the comparison unit and an output terminal of the judgment unit, respectively. A first output terminal of the logic operation unit is configured to output a first switch control signal to control the switching of the first control switch, and a second output terminal of the logic operation unit is configured to output a second switch control signal to control the switching of the second control switch.

In some implementations, the logic operation unit can be constructed from gate circuits according to the required functionality. In other implementations, the logic operation unit may be a programmable device to achieve the desired functionality.

As shown in FIG. 4-6, in some embodiments, the drive circuit 100 includes a data channel unit 200A (as indicated by the dashed box), a first capacitor CAP1, a second capacitor CAP2, and a comparison unit CMP.

The data channel unit 200A includes a data channel 300A, a judgment unit AD1, a logic operation unit 24A, a first control switch SW1_A, and a second control switch SW2_A. The first control switch SW1_A and the second control switch SW2_A provide a circuit on/off control.

The input terminal of the data channel 300A is configured to receive an input signal, and the output terminal of the data channel 300A is configured to output an output signal.

The two input terminals of the comparison unit CMP are connected to one end of the first capacitor CAP1 and the reference voltage VREF, respectively, to compare the voltage VEQ at one end of the first capacitor CAP1 with the reference voltage VREF. The other end of the first capacitor CAP1 is connected to one end of the second capacitor CAP2. The other end of the second capacitor CAP2 is grounded (GND). The output terminal of the comparison unit CMP is configured to output the comparison result, which serves as one input to the logic operation unit 24A.

The judgment unit AD1 is configured to determine the state of the input signal on the data channel 300A and obtain a judgment result which serves as the other input to the logic operation unit 24A.

The first control switch SW1_A is configured to connect the end of the first capacitor CAP1, which is connected to the comparison unit CMP, to the output terminal of the data channel 300A. The second control switch SW2_A is configured to connect the end of the second capacitor CAP2, which is connected to the first capacitor CAP1, to the output terminal of the data channel 300A.

The two input terminals of the logic operation unit 24A are connected to the output terminal of the comparison unit CMP and the output terminal of the judgment unit AD1, respectively. Based on the judgment result and the comparison result, the first output terminal of the logic operation unit 24A is configured to output a first switch control signal VSW1_A to control the on/off state of the first control switch SW1_A, and the second output terminal of the logic operation unit 24A is configured to output a second switch control signal VSW2_A to control the on/off state of the second control switch SW2_A.

The first capacitor CAP1 and the second capacitor CAP2 are configured to collect residual charges on the external data line DL_A. The logic operation unit 24A generates two switch control signals based on the voltage change on the data channel 300A and the voltage change at the end of the first capacitor CAP1, to control the on/off state of the loop between the first capacitor CAP1, the second capacitor CAP2, and the data line DL_A, which allows the residual charges on the data line DL_A to be collected and stored for subsequent charging of the data line DL_A, thereby significantly reducing the power consumption of the display device.

The first control switch SW1_A and the second control switch SW2_A may be, for example, MOSFETs. The gate of the first control switch SW1_A is connected to the first output of the logic operation unit 24A to receive the first switch control signal VSW1_A. The drain of the first control switch SW1_A is connected to one end of the first capacitor CAP1 that is connected to the comparison unit CMP, and the source is connected to the data line DL_A. The gate of the second control switch SW2_A is connected to the second output of the logic operation unit 24A to receive the second switch control signal VSW2_A. The drain of the second control switch SW2_A is connected to the end of the second capacitor CAP2 that is connected to the first capacitor CAP1, and the source is connected to the data line DL_A.

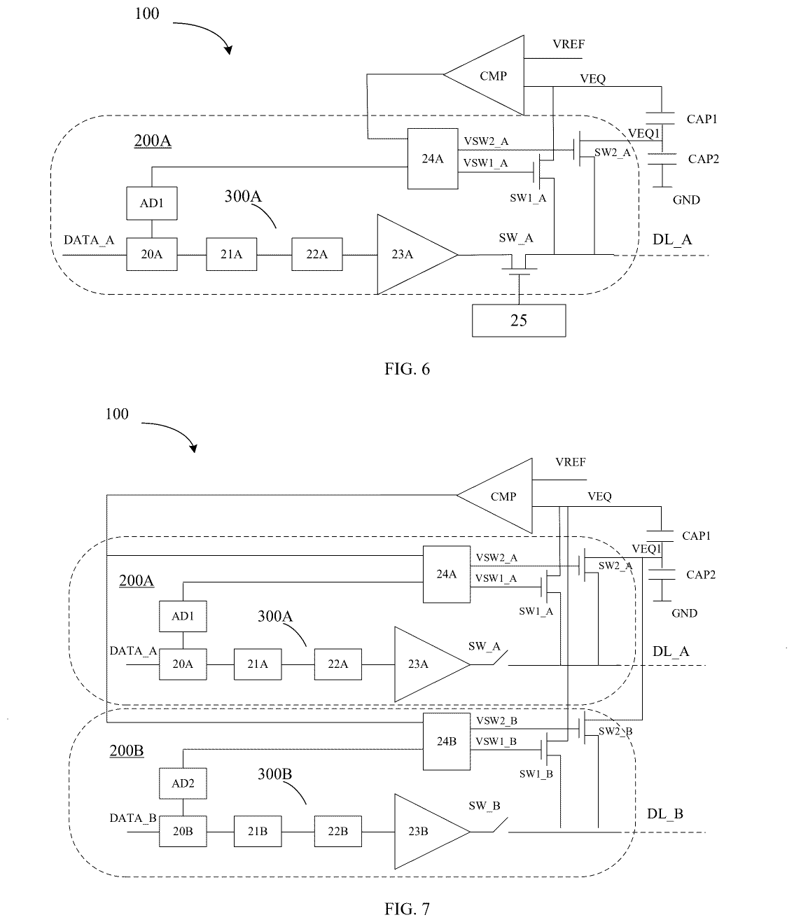

As shown in FIG. 6, in some embodiments, the data channel 300A further includes a latch unit 20A, a level shifting unit 21A, a digital-to-analog conversion unit 22A, an operational amplifier unit 23A, and a data channel switch SW_A, which are connected in series. The data channel switch SW_A is located upstream of connection points of the data channel 300A and the first control switch SW1_A and the second control switch SW2_A, and is configured to control the connection state between the data channel 300A and the data line DL_A. The latch unit 20A is configured to cache the input signal of the data channel 300A. The level shifting unit 21A is configured to perform level conversion on the input signal cached by the latch unit 20A. The digital-to-analog conversion unit 22A is configured to perform digital-to-analog conversion on the output signal of the level shifting unit 21A. The operational amplifier unit 23A is configured to amplify the output signal of the digital-to-analog conversion unit 22A to obtain the output signal of the data channel 300A. The input of the judgment unit AD1 is connected to the output of the latch unit 20A.

Exemplarily, the drive circuit 100 further includes a control unit 25, which is connected to the data channel switch SW_A to control the on/off state of the data channel switch SW_A. The data channel switch SW_A can be, for example, a MOSFET. In some embodiments, before the input signal DATA_A generates a change, such as from 0 to 1 or from 1 to 0, the control unit 25 controls the data channel switch SW_A to be turned off.

The signal at the input of the data channel is denoted as DATA_A, and the voltage at one end of the first capacitor CAP1 connected to the comparator CMP is denoted as VEQ. The first output of the logic operation unit 24A outputs the first switch control signal to the first control switch SW1_A, denoted as VSW1_A, and the second output of the logic operation unit 24A outputs the second switch control signal to the second control switch SW2_A, denoted as VSW2_A.

When the signal DATA_A changes from a low level to a high level, the control operation includes the following two cases.
I. When the voltage VEQ is at a high level, the output first switch control signal VSW1_A is at a high level, turning on the first control switch SW1_A, and the output second switch control signal VSW2_A is at a low level, turning off the second control switch SW2_A. At this point, the circuit between the first capacitor CAP1 and the data line DL_A is closed, allowing the first capacitor CAP1 to charge the data line DL_A.
II. When the voltage VEQ is at a low level, both the first switch control signal VSW1_A and the second switch control signal VSW2_A are at low levels, turning off both the first control switch SW1_A and the second control switch SW2_A. At this point, the circuits between the first capacitor CAP1, the second capacitor CAP2, and the data line DL_A are disconnected, preventing the data line DL_A from charging the first capacitor CAP1 and the second capacitor CAP2.

When the signal DATA_A changes from a high level to a low level, the control operation includes the following two cases.
I. When the voltage VEQ is at a low level, the output first switch control signal VSW1_A is at a high level, turning on the first control switch SW1_A, and the output second switch control signal VSW2_A is at a low level, turning off the second control switch SW2_A. At this point, the circuit between the first capacitor CAP1 and the data line DL_A is closed, allowing the data line DL_A to charge the first capacitor CAP1.
II. When the voltage VEQ is at a high level, the output first switch control signal VSW1_A is at a low level, turning off the first control switch SW1_A, and the output second switch control signal VSW2_A is at a high level, turning on the second control switch SW2_A. At this point, the circuit between the second capacitor CAP2 and the data line DL_A is closed, allowing the data line DL_A to charge the second capacitor CAP2.

In the above-described embodiment, a second switch control signal VSW2_A is output from the logic operation unit 24A to control the second control switch SW2_A. When the signal DATA changes from a high level to a low level, and the voltage VEQ is greater than the reference voltage VREF, the second control switch SW2_A is turned on, storing the residual charge on the data line to the second capacitor CAP2.

When there are two or more data channels, even if data change in different modes for at least two data channels, the voltage variation at the end of the first capacitor does not affect the operation, and the residual charge on each data line is stored into the first capacitor and/or the second capacitor.

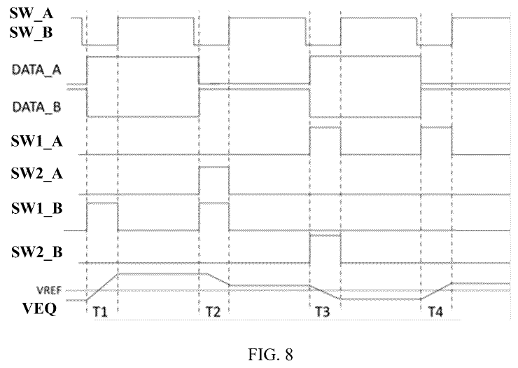

In some embodiments, as shown in FIG. 7, the drive circuit 100 includes independent data channel units 200A and 200B, a first capacitor CAP1, a second capacitor CAP2, and a comparison unit CMP. The structure of data channel units 200A and 200B is the same as that of the data channel unit 200A shown in the embodiments in FIGS. 4-6.

Specifically, the data channel unit 200A includes a data channel 300A, a judgment unit AD1, a logic operation unit 24A, a first control switch SW1_A, and a second control switch SW2_A. The data channel 300A further includes a latch unit 20A, a level shifting unit 11A, a digital-to-analog conversion unit 22A, an operational amplifier unit 23A, and a data channel switch SW_A, which are connected in series. The data channel 300A is connected to an external data line DL_A. The logic operation unit 24A is configured to generate a first switch control signal VSW1_A and a second switch control signal VSW2_A to control a first control switch SW1_A and a second control switch SW2_A, respectively.

The data channel unit 200B includes a data channel 300B, a judging unit AD2, a logic operation unit 24B, a first control switch SW1_B, and a second control switch SW2_B. The data channel 300B further includes a latch unit 20B, a level shifting unit 21B, a digital-to-analog conversion unit 22B, an operational amplifier unit 23B, and a data channel switch SW_B, which are connected in series. The data channel 300B is connected to an external data line DL_B. The logic operation unit 24B is configured to generate a first switch control signal VSW1_B and a second switch control signal VSW2_B to control a first control switch SW1_B and a second control switch SW2_B, respectively.

The specific working principle of the data channel units 200A and 200B, as well as their connection in the drive circuit, are consistent with the implementation as described in FIGS. 4-6, and will not be elaborated here.

The data channels of the data channel units 200A and 200B may have the same or different variation modes of the input signals.

In some embodiments, the logic operation units 24A and 24B in data channel units 200A and 200B share the same output of the comparison unit CMP. The data channel switches SW_A and SW_B in data channel units 200A and 200B adopt the same operating timing.

The operation of the drive circuit 100 is described below in conjunction with the exemplary signal timing shown in FIG. 8. For ease of description, the input signal corresponding to data channel 200A is denoted as DATA_A, and the connected data line is denoted as DL_A. The input signal corresponding to data channel 200B is denoted as DATA_B, and the connected data line is denoted as DL_B. The voltage at the end of the first capacitor CAP1 connected to the comparison unit CMP is denoted as VEQ, the voltage at the end of the second capacitor CAP2 connected to the first capacitor CAP1 is denoted as VEQ1, and the reference voltage is denoted as VREF.

In this embodiment, the data channel switches SW_A and SW_B adopt the same working timing. Before any change occurs in the input signals DATA_A and DATA_B, such as from 0 to 1 or from 1 to 0, SW_A and SW_B will be turned off, and will be turned on after a predetermined time. In the exemplary timing diagram, a low level represents the switch being off, and a high level represents the switch being on.

Initially, the voltage VEQ is lower than the reference voltage VREF. During the period T1, the signal DATA_A changes from low to high, and the signal DATA_B changes from high to low. As a result, the first control switch SW1_B is turned on, and the other control switches are turned off, which allows the residual charge on the data line DL_B to charge the first capacitor CAP1. In this case, the voltage VEQ1 is half of the voltage VEQ, and both the voltages VEQ1 and VEQ rise simultaneously, causing VEQ to reach a value greater than the reference voltage VREF.

During the period T2, the signal DATA_B changes from low to high, and thus the first control switch SW1_B is turned on, charging the data line DL_B with capacitor CAP1. As the charging process proceeds, the voltage VEQ decreases. Meanwhile, the signal DATA_A changes from high to low, so the first control switch SW1_A is turned off, and the second control switch SW2_A is turned on. At this time, the residual charge on the data line DL_A is collected by the second capacitor CAP2, causing the voltage VEQ1 to rise, and VEQ rises along with the voltage VEQ1. At this point, charging and discharging occur simultaneously. If the rise of voltage VEQ is smaller than the decrease, it may cause VEQ to be lower than the reference voltage VREF, and in this case, the residual charge on the data line will be collected into the first capacitor CAP1 and second capacitor CAP2 (the process is the same as the T1 period, which is not repeated here). In this illustrated example, the final voltage VEQ during T2 is greater than the reference voltage VREF.

During the period T3, the signal DATA_A switches from low to high, and the first control switch SW1_A is turned on. The data line DL_A is charged with the charges in the first capacitor CAP1 and the second capacitor CAP2. During this process, the voltage VEQ gradually decreases. Meanwhile, the signal DATA_B switches from high to low, and the first control switch SW1_B is turned off while the second control switch SW2_B is turned on. The residual charge on the data line DL_B is stored in the second capacitor CAP2. As the charging process continues, the voltage VEQ rises along with the voltage VEQ1. Thus, charging and discharging occur simultaneously. In the illustrated embodiment, the voltage VEQ decreases more than it increases, resulting in VEQ falling below the reference voltage VREF.

During the T4 period, the signal DATA_A changes from high to low, which turns on the first control switch SW1_A and turns off the second control switch SW2_A. The residual charge on the data line DL_A is used to charge the first capacitor CAP1. Meanwhile, the signal DATA_B changes from low to high, which turns off both the first control switch SW1_B and the second control switch SW2_B. During this time, the voltage VEQ gradually increases, and VEQ1 rises along with the voltage VEQ and is equal to half of the voltage VEQ.

Thus, based on the drive circuit in this embodiment, regardless of the voltage levels of VEQ, the residual charges on the data lines can be fully collected and used to charge the data lines again, effectively reducing the power consumption of the drive circuit.

From the above description of the drive circuit and its operation, those skilled in the art can easily understand that the present disclosure can also be applied to more than two data channel units, which can similarly store the charges on the data lines, thereby reducing the power consumption of the drive circuit. The data channels of the more than two data channel units may have the same or different variation modes of the input signals.

The present disclosure also provides a display device that includes a drive circuit as described in the previous embodiments and one or more data lines connected to the drive circuit.

According to the display device of the present disclosure, it is possible to fully collect and store the residual charges on the one or more data lines for subsequent charging of the one or more data lines, thereby significantly reducing the power consumption of the display device.

The present disclosure further provides a control method for a drive circuit, applied to the drive circuit in the above various embodiments. The control method includes controlling the data channel switch to turn off before an input signal changes.

According to the control method of the drive circuit in the present disclosure, it is possible to fully collect and store the residual charges on the one or more data lines for subsequent charging of the one or more data lines, thereby significantly reducing the power consumption of the display device.

In the description of this specification, the terms “some embodiments”, “other embodiments”, etc., refer to specific features, structures, materials, or characteristics described in conjunction with a particular embodiment or example, which are included in at least one embodiment or example of the present disclosure. The illustrative description of the above terms does not necessarily refer to the same embodiment or example.

The technical features of the embodiments described above can be combined in any manner. To keep the description concise, not all possible combinations of the technical features in the above embodiments are described. However, as long as these combinations of technical features do not conflict, they should be considered within the scope of the present disclosure.

The embodiments described above only represent a few possible implementations of the present disclosure, and the description is more specific and detailed. However, this should not be understood as a limitation of the scope of the application. It should be pointed out that, for those skilled in the art, several modifications and improvements can be made without departing from the inventive concept of the present disclosure, and these are all within the scope of the protection. Therefore, the scope of protection of the present disclosure should be determined by the appended claims.

What is claimed is:

1. A drive circuit for a display device, comprising one or more data channel units, a first capacitor, a second capacitor, and a comparison unit, two input terminals of the comparison unit being connected to one end of the first capacitor and a reference voltage respectively, and the other end of the first capacitor being connected to one end of the second capacitor,
wherein the one or more data channel units each comprise:
a data channel, an input terminal of the data channel being configured to receive an input signal, and the output terminal of the data channel being configured to output an output signal;
a judgment unit, connected to the data channel and configured to determine a state of the input signal;
a first control switch and a second control switch, the first control switch being connected to the output terminal of the data channel and one end of the first capacitor connected to the comparison unit, and the second control switch being connected to the output terminal of the data channel and one end of the second capacitor connected to the first capacitor; and
a logic operation unit, two input terminals of the logic operation unit being connected to an output terminal of the comparison unit and an output terminal of the judgment unit, respectively, a first output terminal of the logic operation unit being configured to output a first switch control signal to control switching of the first control switch, and a second output terminal of the logic operation unit being configured to output a second switch control signal to control switching of the second control switch.

2. The drive circuit according to claim 1, wherein the data channel comprises a latch unit, a level shift unit, a digital-to-analog conversion unit, and an operational amplifier unit, which are connected in series, the latch unit is configured to cache the input signal, the level shift unit is configured to perform level conversion on the input signal cached by the latch unit, the digital-to-analog conversion unit is configured to perform digital-to-analog conversion on an output signal of the level shift unit, and the operational amplifier unit is configured to amplify an output signal of the digital-to-analog conversion unit to obtain the output signal of the data channel.

3. The drive circuit according to claim 2, wherein an input terminal of the judging unit is connected to an output terminal of the latch unit.

4. The drive circuit according to claim 1, wherein the output terminal of the data channel is configured to be connected to an external data line, and the first capacitor and the second capacitor are configured to collect residual charge on the data line and charge the data line with the collected charge.

5. The drive circuit according to claim 4, wherein the data channel unit further comprises a data channel switch, the data channel switch is connected in the data channel and positioned upstream of connection points between the data channel and the first control switch and the second control switch, and is configured to control a connection state between the data channel and the data line.

6. The drive circuit according to claim 5, further comprising a control unit, wherein the control unit is configured to turn off the data channel switch before a change occurs in the input signal.

7. The drive circuit according to claim 1, wherein a gate of the first control switch is connected to the first output terminal of the logic operation unit, a drain of the first control switch is connected to the end of the first capacitor connected to the comparison unit, a source of the first control switch is connected to the output terminal of the data channel, a gate of the second control switch is connected to the second output terminal of the logic operation unit, a drain of the second control switch is connected to the end of the second capacitor connected to the first capacitor, and a source of the second control switch is connected to the output terminal of the data channel.

8. The drive circuit according to claim 1, wherein a voltage at the end of the first capacitor connected to the comparison unit is denoted as VEQ, and the logic operation circuit is configured to:
when the input signal of the data channel transitions from low to high and the voltage VEQ is at a high level, turn on the first control switch and turn off the second control switch to close a circuit between the first capacitor and the data line; and
when the input signal of the data channel transitions from low to high and the voltage VEQ is at a low level, turn off both the first control switch and the second control switch to disconnect the circuit the first capacitor and data line and a circuit between the second capacitor and the data line.

9. The drive circuit according to claim 1, wherein a voltage at the end of the first capacitor connected to the comparison unit is denoted as voltage VEQ, and the logic operation circuit is configured to:
when the input signal of the data channel transitions from high to low and the voltage VEQ is at a high level, turn off the first control switch and turn on the second control switch to close a circuit between the second capacitor and the data line; and
when the input signal of the data channel transitions from high to low and the voltage VEQ is at a low level, turn on the first control switch and turn off the second control switch to close a circuit between the first capacitor and the data line.

10. The drive circuit according to claim 1, wherein the one or more data channel units comprise a plurality of independent data channel units, and the data channels of the plurality of data channel units are configured to receive the input signals with same or different variation modes.

11. A display device, comprising a drive circuit and one or more data lines connected to the drive circuit, the drive circuit comprising one or more data channel units, a first capacitor, a second capacitor, and a comparison unit, two input terminals of the comparison unit being connected to one end of the first capacitor and a reference voltage respectively, and the other end of the first capacitor being connected to one end of the second capacitor,
wherein the one or more data channel units each comprise:
a data channel, an input terminal of the data channel being configured to receive an input signal, and the output terminal of the data channel being configured to output an output signal;
a judgment unit, connected to the data channel and configured to determine a state of the input signal;
a first control switch and a second control switch, the first control switch being connected to the output terminal of the data channel and one end of the first capacitor connected to the comparison unit, and the second control switch being connected to the output terminal of the data channel and one end of the second capacitor connected to the first capacitor; and
a logic operation unit, two input terminals of the logic operation unit being connected to an output terminal of the comparison unit and an output terminal of the judgment unit, respectively, a first output terminal of the logic operation unit being configured to output a first switch control signal to control switching of the first control switch, and a second output terminal of the logic operation unit being configured to output a second switch control signal to control switching of the second control switch.

12. The display device according to claim 11, wherein the data channel comprises a latch unit, a level shift unit, a digital-to-analog conversion unit, and an operational amplifier unit, which are connected in series, the latch unit is configured to cache the input signal, the level shift unit is configured to perform level conversion on the input signal cached by the latch unit, the digital-to-analog conversion unit is configured to perform digital-to-analog conversion on an output signal of the level shift unit, and the operational amplifier unit is configured to amplify an output signal of the digital-to-analog conversion unit to obtain the output signal of the data channel.

13. The display device according to claim 12, wherein an input terminal of the judging unit is connected to an output terminal of the latch unit.

14. The display device according to claim 11, wherein the output terminal of the data channel is configured to be connected to an external data line, and the first capacitor and the second capacitor are configured to collect residual charge on the data line and charge the data line with the collected charge.

15. The display device according to claim 14, wherein the data channel unit further comprises a data channel switch, the data channel switch is connected in the data channel and positioned upstream of connection points between the data channel and the first control switch and the second control switch, and is configured to control a connection state between the data channel and the data line, and
wherein the drive circuit further comprises a control unit configured to turn off the data channel switch before a change occurs in the input signal.

16. The display device according to claim 11, wherein a gate of the first control switch is connected to the first output terminal of the logic operation unit, a drain of the first control switch is connected to the end of the first capacitor connected to the comparison unit, a source of the first control switch is connected to the output terminal of the data channel, a gate of the second control switch is connected to the second output terminal of the logic operation unit, a drain of the second control switch is connected to the end of the second capacitor connected to the first capacitor, and a source of the second control switch is connected to the output terminal of the data channel.

17. The display device according to claim 11, wherein a voltage at the end of the first capacitor connected to the comparison unit is denoted as VEQ, and the logic operation circuit is configured to:
when the input signal of the data channel transitions from low to high and the voltage VEQ is at a high level, turn on the first control switch and turn off the second control switch to close a circuit between the first capacitor and the data line; and
when the input signal of the data channel transitions from low to high and the voltage VEQ is at a low level, turn off both the first control switch and the second control switch to disconnect the circuit the first capacitor and data line and a circuit between the second capacitor and the data line.

18. The display device according to claim 11, wherein a voltage at the end of the first capacitor connected to the comparison unit is denoted as voltage VEQ, and the logic operation circuit is configured to:
when the input signal of the data channel transitions from high to low and the voltage VEQ is at a high level, turn off the first control switch and turn on the second control switch to close a circuit between the second capacitor and the data line; and
when the input signal of the data channel transitions from high to low and the voltage VEQ is at a low level, turn on the first control switch and turn off the second control switch to close a circuit between the first capacitor and the data line.

19. The display device according to claim 11, wherein the one or more data channel units comprise a plurality of independent data channel units, and the data channels of the plurality of data channel units are configured to receive the input signals with same or different variation modes.

20. A control method for a display device, the display device comprising the drive circuit according to claim 5, wherein the control method comprises:
turning off the data channel switch before the input signal changes.
